(19) United States
(12) Patent Application Publication
(10) Pub. No.: US 2011/0132117 A1
(43) Pub. Date: Jun. 9, 2011

(54) Variable torque transmitting device

(76) Inventor: John Christian Yaeger, Lawrenceville, GA (US)

(21) Appl. No.: 12/928,174

(22) Filed: Dec. 6, 2010

Related U.S. Application Data
(60) Provisional application No. 61/283,832, filed on Dec. 9, 2009.

(51) Int. Cl. F16H 1/04

(52) U.S. Cl. 74/412 R

(57) ABSTRACT

A torque transmitting device uses a continuously meshed face gear and at least one pinion supported by a carrier that adjusts the position of the pinions. The position of the pinions changes the amount of self-locking at the gear teeth. Controlling the position of the pinions on the face gear varies the amount of torque transferred between the face gear and the carrier supporting the pinion or pinions. Torque transfer can be varied throughout a range between low or negligible levels and a fully engaged state without the need for a fixed relationship between torque transfer and gear ratio.

### CROSS REFERENCE TO RELATED APPLICATIONS

This application claims the benefit of PPA Ser. No. 61/283,832 Filed 2009 Dec. 9, by the present inventor, which is incorporated by reference

### BACKGROUND OF THE INVENTION

1. Prior Art

United States Patent References

| | | | |
|---|---|---|---|
| 1,683,758 | Sep. 11, 1928 | 2,954,704 | Oct. 4, 1960 |
| 1,694,028 | Dec. 4, 1928 | 3,645,148 | Feb. 29, 1972 |
| 2,028,148 | Jan. 21, 1936 | 3,768,326 | Oct. 30, 1973 |
| 2,696,125 | Dec. 7, 1954 | 4,226,136 | Oct. 7, 1980 |

Previously, varying torque transfer between rotating parts has been achieved with friction clutches, belt drives, fluid impellers, electric motor/generators, and hydraulic pump and motor arrangements. Drawbacks include losses and wear when friction clutches and belts are slipped to vary engagement. Fluid impellers and electric motor/generators lack solid mechanical engagement. All can suffer from heat buildup. Often, complex gear trains are needed to minimize these drawbacks while controlling one or more inputs or outputs.

2. Objects and Advantages

Accordingly, several objects of this invention are to provide continuously adjustable control of torque transfer throughout a range between low or negligible levels and a fully engaged state. This is accomplished by varying the position of continuously meshed gears in order to vary the self-locking of the gear teeth. Advantages include solid mechanical engagement at all times, wear limited to standard gear wear, and losses limited to gear friction when relative rotation occurs between the input and output. Furthermore, a fixed relationship between torque transfer and gear ratio is avoided.

### SUMMARY OF THE INVENTION

In accordance with the invention, the position of at least one pinion on a face gear is varied in order to control the self-locking of the pinion, thereby controlling torque transmission.

### DRAWING DESCRIPTIONS

FIG. 1 shows a face gear and pinion adjusted for substantial self-locking at the gear teeth.

FIG. 2 shows the face gear and pinion of FIG. 1 adjusted for low or negligible self-locking at the gear teeth.

FIG. 3 shows a face gear, a pinion, and a rotatable carrier of interconnected struts used to vary the position of the pinion.

FIG. 4 shows a face gear, a pinion, a slidable pinion mount, and two rotatable carriers to vary the position of the pinion mount.

FIG. 5 shows a face gear, a pinion, a rotatable carrier, and a shaft to carry and vary the position of the pinion.

REFERENCE NUMERALS

| | |
|---|---|
| 10 | face gear |
| 12 | pinion |
| 14 | strut |
| 16 | central carrier |
| 18 | slidable pinion mount |
| 20 | rotatable carrier |
| 22 | rotatable carrier |
| 24 | rotatable carrier |
| 26 | shaft |

### DETAILED DESCRIPTIONS

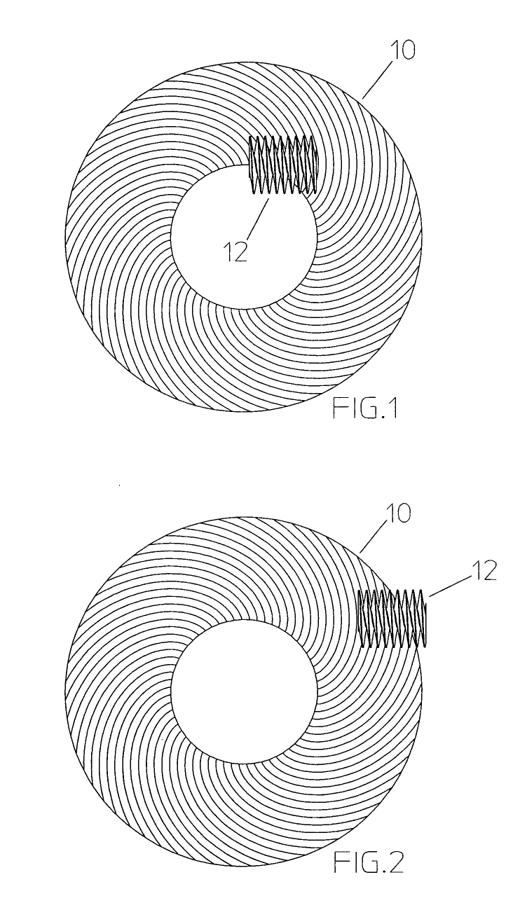

FIG. 1 is oriented along the axis of a face gear 10. The teeth are constructed to accommodate a worm-type pinion with a constant lead. The teeth are approximated with involute paths, though many geometries developed in the field of skew-axis gearing could be used. A pinion 12 is meshed with face gear 10. The pinion 12 may be cylindrical or tapered. It is desirable for the pinion 12 to have a constant lead, creating equal tooth spacing to allow meshing at any point along face gear 10.

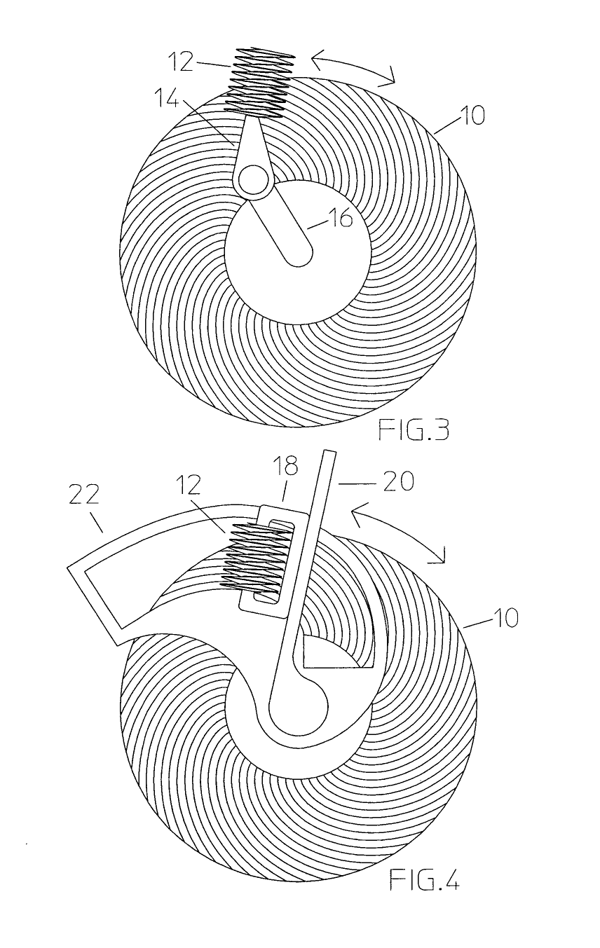

FIG. 2 is oriented along the axis of face gear 10. Pinion 12 is meshed with face gear 10 near the outer circumference.

FIG. 3 is oriented along the axis of face gear 10. Pinion 12 is meshed with face gear 10 and constrained by strut 14. Strut 14 is rotatably attached to central carrier 16. Not shown are means to vary the angular relationship between strut 14 and central carrier 16.

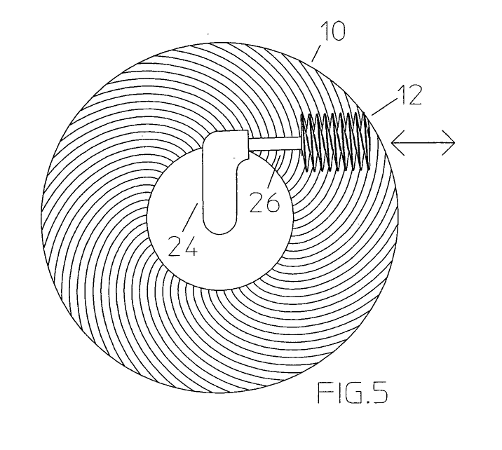

FIG. 4 is oriented along the axis of face gear 10. Pinion 12 is meshed with face gear 10 and axially rotatable about a slidable pinion mount 18. Slidable pinion mount 18 is free to move in the axial direction of pinion 12 along rotatable carrier 20. Slidable pinion mount 18 is also constrained by a guide or guides formed by rotatable carrier 22. Not shown are means to vary the angular relationship between rotatable carriers 20 and 22.

FIG. 5 is oriented along the axis of face gear 10. Pinion 12 is meshed with face gear 10 and mounted on shaft 26. Shaft 26 is mounted on rotatable carrier 24. Rotational freedom about the pinion axis is necessary either between pinion 12 and shaft 26 or between shaft 26 and rotatable carrier 24. Shaft 26 is used to vary the position of pinion 12 by using the pinion as a lead screw. Not shown are means to control the relationship between pinion 12 and shaft 26.

### OPERATION

In the case of worm gears, self-locking occurs when a high enough proportion of driving force is applied along the axis of the worm to prevent it from rotating. In FIG. 1, worm pinion 12 is meshed with face gear 10 such that the rotation of face gear 10 is directed along the axis of pinion 12. This creates high self-locking. If pinion 12 is constrained by a carrier rotatable about the axis of face gear 10, torque applied around said axis to either face gear 10 or said carrier will rotate the two together and transfer a all or a majority of the torque applied.

In FIG. 2, worm pinion 12 is meshed with face gear 10 such that the rotation of face gear 10 is more perpendicular to the axis of pinion 12. This creates low self-locking. If pinion 12 is constrained by a carrier rotatable about the axis of face gear 10, torque applied around said axis to either face gear 10 or said carrier will allow substantial rotation between the two and transfer a reduced or negligible amount of the torque applied.

For many skew axis gearsets, the path of continuous mesh follows the axis of the pinion. This has historically been used to adjust backlash characteristics. For more significant changes in the location of pinion 12, the angle of the axis of pinion 12 varies relative to the tangent of rotation of face gear 10. This consequence of geometry varies the self-locking of the gear teeth, and allows torque transfer to be controlled by adjusting the position of pinion 12 with face gear 10. It may be useful to allow pinion 12 to move partially off face gear 10, maintaining mesh only at one end. Gear geometry could be created with high enough lead angles that the path of continuous mesh could be at an angle or even perpendicular to the axis of the pinion. This might result in a gearset where self-locking is higher at the outside of the face gear and lower at the inside.

Controlling the position of pinion 12 can be accomplished several ways. FIG. 3 shows a strut 14 that moves pinion 12 through a sweep. The specific geometry of strut 14 and its attachment to central carrier 16 will need to reflect the needs of continuous mesh while changing self-locking characteristics. Ideally, geometry will be selected to achieve this with minimum slip due to rolling pinion 12. Strut 14 and pinion 12 may also need to move in the direction of the view to accommodate any taper in the pinion or bevel in the face gear. Central carrier 16, strut 14, and pinion 12 are rotatable relative to face gear 10 about the axis of face gear 10 when there is a low degree of self-locking at pinion 12. The actuation of strut 14 could be accomplished with a variety of mechanisms, not limited to gear drives, helical splines, solenoids, magnets, electric motors, hydraulics, or pneumatics.

FIG. 4 shows rotatable carriers 20 and 22 that move slidable pinion mount 18 and pinion 12 through a sweep. Slidable pinion mount 18 is free to move along the length of rotatable carrier 20 while following a guide or guides formed by rotatable carrier 22. Pinion 12 is axially rotatable about slidable pinion mount 18. Rotatable carriers 20 and 22, slidable pinion mount 18, and pinion 12 are rotatable relative to face gear 10 about the axis of face gear 10 when there is a low degree of self-locking at pinion 12. In this way, the position and self-locking characteristics of pinion 12 are controlled by varying the angular relationship between rotatable carriers 20 and 22. Varying the angular relationship between rotatable carriers 20 and 22 could be accomplished with a variety of mechanisms, not limited to gear drives, helical splines, solenoids, magnets, electric motors, hydraulics, or pneumatics. The specific geometry of the guides of rotatable carriers 20 and 22 will need to maintain the angle of pinion 12 relative to the involute teeth of face gear 10 at the mesh. Rotatable carriers 20 and 22 may also need to accommodate any taper in the pinion or bevel in the face gear. Ideally, geometry will be selected to achieve this with minimum slip due to rolling pinion 12.

In FIG. 5 face gear 10 is meshed with pinion 12. Pinion 12 is used as a lead screw to vary its position. Pinion 12 is connected with rotatable carrier 24 by shaft 26. To allow relative rotation between face gear 10 and the carrier assembly when there is a low degree of self-locking, rotational freedom about the pinion axis is necessary between either pinion 12 and shaft 26 or between shaft 26 and rotatable carrier 24. Allowing shaft 26 to rotate relative to rotatable carrier 24 would allow the use of helical splines and reduce actuation of pinion 12 to a linear motion. If instead pinion 12 rotates relative to shaft 26, actuation will need to add or subtract from relative motion between the two. The actuation of pinion 12 could be accomplished with a variety of mechanisms, not limited to gear drives, helical splines, solenoids, magnets, electric motors, hydraulics, or pneumatics.

The actuation and retention of pinion 12 is not limited to the means described above, and could be accomplished with different configurations of the described components, or the addition of further components, not limited to additional gearsets, solenoids, magnets, or pneumatic or hydraulic actuation. Any system will need to take the rotation of the carrier assembly into consideration. Many existing mechanisms in the field of camshaft timing, for example, may prove useful. It may be useful to use relative rotation between the face gear, pinion, or carrier to vary the pinion position. Additionally, it may be useful for pinion 12 to be adjustable whether the assembly is rotating or at rest.

### CONCLUSION, RAMIFICATIONS, AND SCOPE

The described gears in combination with carriers and actuators allow variable torque transmission with continuous mesh and without a fixed relationship between torque transmission and gear ratio. This allows continuous operation in an unlocked or slipping condition without undue wear, and high efficiency in a locked or fully engaged state. Actuation can allow a variable torque limit whether the assembly is static or rotating.

Although the description above contains many specificities, these should not be construed as limiting the scope of the embodiments but as merely providing illustrations of some of several embodiments. For example, the carriers can feature other shapes or repeated components; the proportions of the pinion and face gear may be vastly different, etc.

Thus, the scope of the embodiments should be determined by the appended claims and their legal equivalents, rather than by the examples given.

I claim:

1. A variable torque transmitting device comprising:
(a) a face gear and at least one pinion with gear geometry to allow continuous meshing through a range of pinion positions
(b) a carrier to vary and hold the position of said pinion or pinions.
(c) means to vary and hold the position of said carrier and said pinion, whereby self-locking at said pinion teeth and torque transmission between said face gear and said carrier can be varied between low or negligible levels and a fully engaged state.

2. The device in claim 1, where said carrier comprises a center mount and a strut or struts to vary and hold the position of said pinions along a path.

3. The device of claim 1, where the carrier comprises a guide or guides and a slidable pinion mount or mounts to vary and hold the position of said pinions.

4. The device in claim 1, where said carrier uses the pinion or pinions as lead screws to vary and hold their position.
